(19) United States
(12) Patent Application Publication
(10) Pub. No.: US 2008/0137487 A1
(43) Pub. Date: Jun. 12, 2008

(54) Mechanism for Displaying Figures or Signs Produced on a Timepiece Dial

(76) Inventors: Mathias Buttet, Divonne les Bains (FR); Enrico Barbasini, Ambilly (FR); Michel Navas, Collonges (FR)

Correspondence Address: OSTROLENK FABER GERB & SOFFEN, 1180 AVENUE OF THE AMERICAS, NEW YORK, NY, 100368403, US

(21) Appl. No.: 11/574,374

(22) PCT Filed: Aug. 31, 2004
(86) PCT No.: PCT/EP04/09691

§ 371 Date: Feb. 27, 2007

(51) Int. Cl. G04B 19/10; G04B 19/247

(52) U.S. Cl. 368/37; 368/232

(57) ABSTRACT

The inventive mechanism comprises a series of toothed wheels meshing each with other or by groups and driven by a mobile which is connected to a basic timepiece movement by means of a mobile, wherein each toothed wheel is superimposed by a plate or disc carrying figures or signs and rotating in a corresponding bore of the timepiece dial.

The object of the invention is a mechanism for display of animated numbers, figures or signs on a timepiece dial, especially to display the hour.

For a number of years, “novelty” models (of a “fun” or psychedelic nature) have existed on the watch market, including certain Swatches or Silberstein watches or the Opus III by Harry Winston.

All of these timepieces present the particularity of being original and in line with a fashion mood, but in general their major fault is difficulty in reading the time.

The display mechanism according to the invention can equip a manual winding, automatic, quartz or autoquartz basic movement and presents the particularity of animating the dial of the watch by reconstituting a given pattern for a chosen period (from one minute to 24 hours).

The additional mechanism for display of animated numbers, figures or signs on a timepiece dial is characterised in that it comprises at least one toothed wheel placed under an opening of a dial of a timepiece and driven by means of a mobile which is itself linked with the basic movement of the timepiece, the toothed wheel being surmounted by a small plate carrying at least one number, figure or sign designed to be animated in relation to the dial.

According to one mode of execution, the mechanism comprises several toothed wheels linked with each other or controlled separately or in groups.

The mechanism may comprise a first series of 12 toothed wheels placed on the outer part of the mechanism and second series of 6 toothed wheels placed between the centre of the dial and the first series of 12 toothed wheels.

In a preferred mode of execution, the small plates surmounting the toothed wheels are disks designed to rotate in a corresponding opening of the dial. The disks may be positioned at the same level as the dial or positioned to stand out with respect to the level of the dial or inlaid under the dial.

The mechanism may be constructed to animate at least one or several groups of disks. The disks are generally used to animate an image carrying a succession of numbers designed to indicate the hour. They are designed to animate the hour, but in a variant they may indicate the minute, the month, the days of the week, the seasons, the equinoxes, the solstices, day and night, etc.

The drawing represents, as an example, a mode of execution of a mechanism for display of animated figures or signs on a timepiece dial, the object of the invention.

In the drawings:

FIG. 1 is a schematic top view of the mechanism,

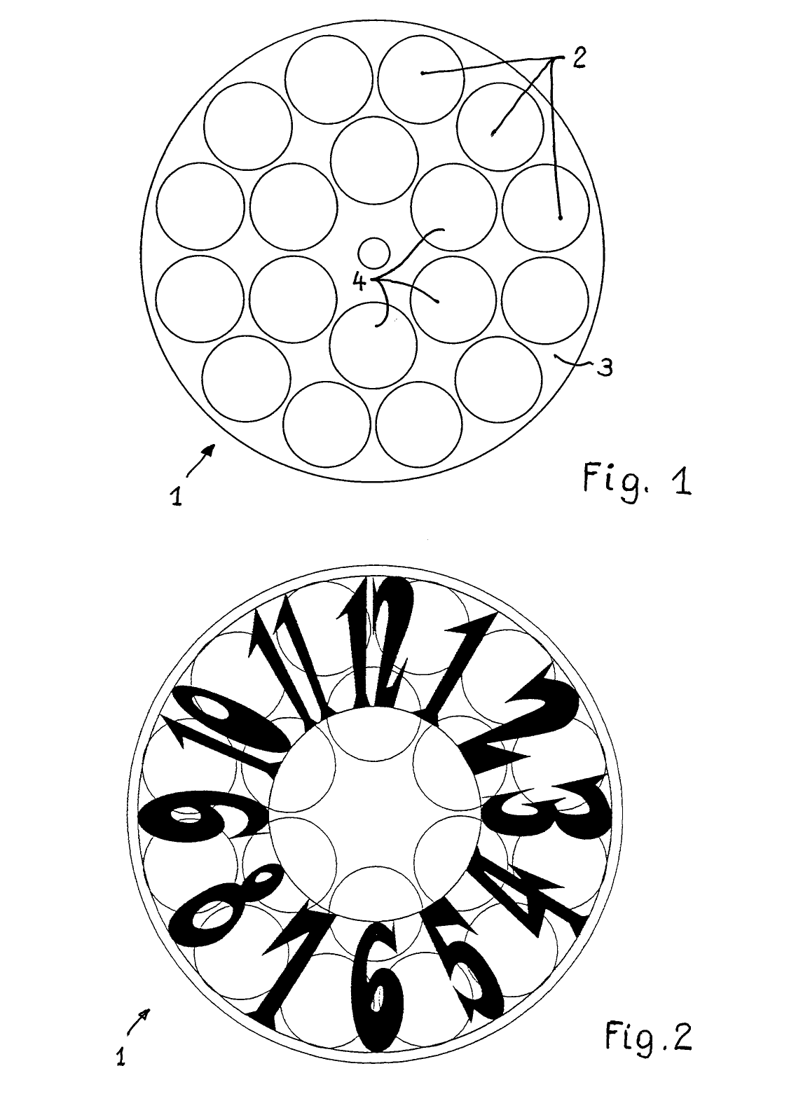

FIG. 2 is a top view of the mechanism, the dial of the mechanism having been equipped with signs to be animated, representing the hours to be displayed,

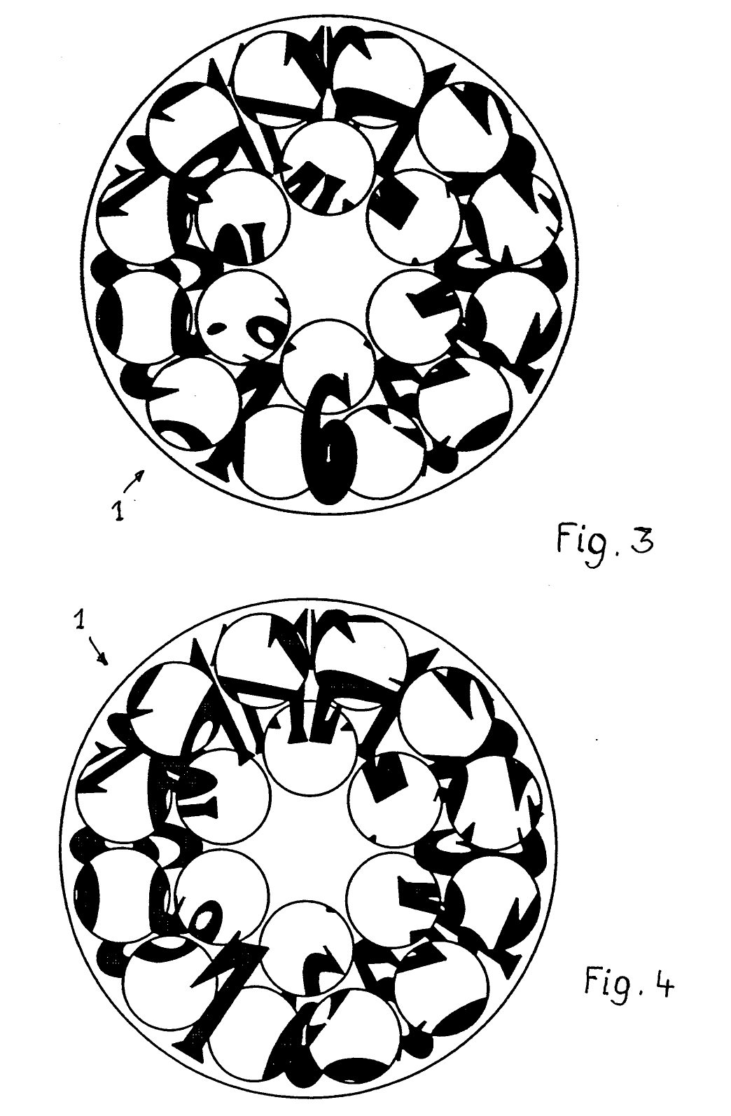

FIG. 3 is view similar to that in FIG. 1, the mechanism having been placed in animation, the indication of a single sign, the number “6”, being visible,

FIG. 4 is a view similar to that shown in FIG. 3 after a time period of one hour has elapsed, the dial displaying the number “7”, the number “6” and all the other numbers being broken up,

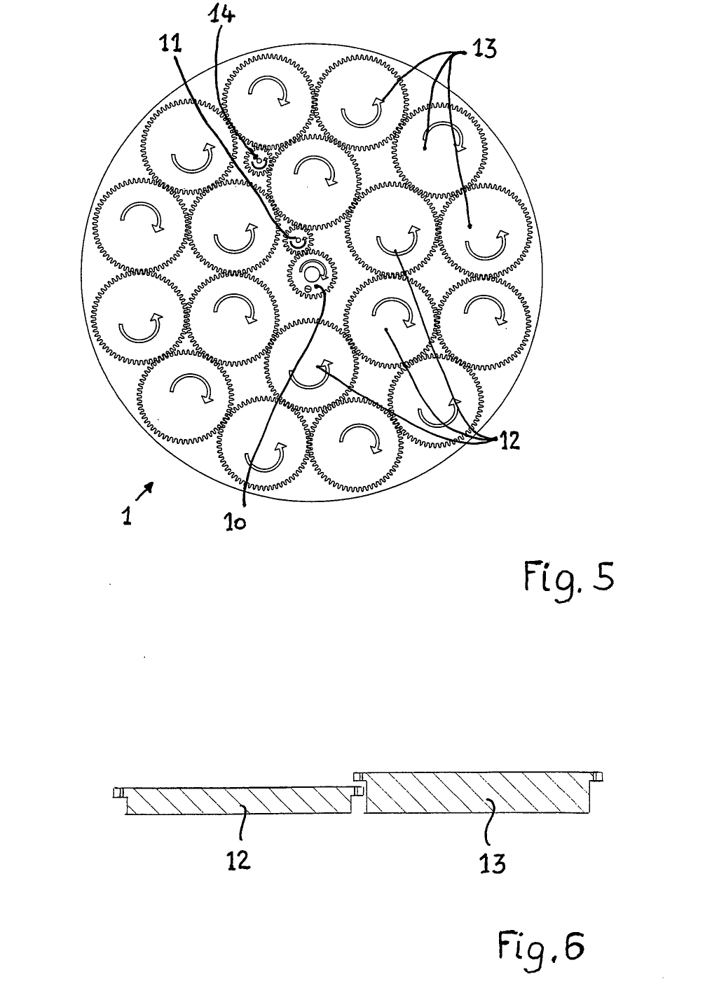

FIG. 5 is a top view of the drive device of a mechanism as shown in FIGS. 1 to 4,

FIG. 6 is a cross section along the line VI-VI in FIG. 5.

The mechanism shown in the drawing is presented in the form of an additional module which can equip timepieces, notably a manual winding basic movement, an automatic movement or a quartz or autoquartz movement. It presents the particularity of animating the dial of the timepiece by reconstituting successively the signs from “1” to “12” for a period chosen beforehand, corresponding to a time period of one hour.

FIG. 1 explains the layout of moving parts of the dial. This layout is not exhaustive and may be modified at will, but the figure represents an example of a drawing, made in accordance with the quantity of signs to be represented.

The mechanism (1) consists of twelve disks (2) distributed uniformly on the minute track of a dial (3) and placed midway between the positions of the hour pointers. Alternatively, the position of the disks (2) could coincide with the point at which the pointers indicating the hours are usually located.

An additional series of six disks (4) of the same diameter as the disks (2) are distributed concentrically around the dial (3) and positioned at an angular half-pitch value with respect to the first series of twelve disks (2). All of the disks (2 and 4) will be driven by the mechanism as described below and the disks (2 and 4) will be placed in corresponding openings in the dial (3), so that they are in the same plane as the dial (3).

When the mechanism (1) drives the disks (2 and 4), the uncut part of the dial (3) may present a decoration which remains fixed; the 18 disks, for their part, may be animated in rotation at a speed chosen between less than a minute and at most 12 hours (FIG. 2 to 4). The image represented in FIG. 2 is thus broken up and the numbers are successively reconstituted after a time period of one hour.

In the case cited above, the disks (2 and 4) are trailing, that is to say they move in a linear fashion, successively forming the numbers to be displayed without ever really stopping. Preferably, the mechanism (1) will be constructed to stop for one hour on each number reconstituted.

FIG. 2 shows the reconstitution of the hours “1” to “12” positioned in a standard way on the dial (3) and on the disks (2 and 4).

It is clear for the professional that the dial (3) and the disks (2 and 4) will never display in functioning the image shown in FIG. 2.

As shown in FIGS. 3 and 4, when the elements of the mechanism (1) are assembled, the disks (2 and 4) are placed in an offset position, in rotation with respect to the previous disk, so that in groups of three the offset is 30° from one group to another, the speed of rotation of the 18 disks being one revolution per hour. Thus, every hour, a single number indicating the hour will be reconstituted.

In FIG. 3 it can be seen that that the number “6” is reconstituted, whereas in FIG. 4 we move on after a time period of one hour and an offset of 30° to the reconstitution of the number “7”.

It is possible to imagine reading the time without an hour hand, the hour being indicated by the reconstituted number, but in this precise case a reading problem arises: the reconstituted number would take a full hour to reconstitute itself over a variation of 30°, which means that it would be possible to read the hour number perfectly only when the time is X hours and 30 minutes.

According to a preferred variant, the mechanism will be constructed to stop at the time of reconstitution of each number and make a jump after a time period of one hour, the 30° offset of the disks (2, 4) being instantaneously made up at the time of this jump.

The mechanism carrying the disks (2 and 4) is represented in FIG. 5 and functions as follows: The wheel or mobile (10) is attached to a mobile which is part of the basic movement of the timepiece which is fitted with the additional mechanism (1), like for example the hour wheel of a basic calibre or its minute wheel work, or any other mobile.

The mobile (10) rotates in the clockwise direction and meshes directly with a mobile (11) which rotates in the anti-clockwise direction. The latter drives a wheel (12) in the clockwise direction. The wheel (12) is identical to the other 17 wheels (12 and 13) composing the mobile (18 including it). These 18 wheels successively represent the 6 inner wheels (12) and the 12 outer wheels (13). Each of these wheels carries a disk (2, 4). These disks are visible on the dial side and give by their movement the desired animation on the dial side. In our case, it is an added patch which has a disk effect and which is attached to these wheels (12, 13). As can be seen in the drawing, these wheels (12, 13) have the same diameter. The wheel (12) rotating in the clockwise direction is positioned at the same height level as the other 5 wheels (12) in its group, causing the mobiles to rotate alternately in the clockwise and anti-clockwise direction. The number of wheels in the group being even, this enables the last wheel to mesh with the first wheel without blocking it as it is rotating in the opposite direction. These 6 wheels can therefore be driven by any one of these 6 wheels. In other words, the pinion (11) may be located angularly all around the mobile (10) in such a way as to mesh with one of the 6 wheels (12).

The 12 outer wheels (13) of the same diameter as the 6 wheels cited above are positioned at a different height so that the teeth of these wheels do not touch the lower wheels (12). The pinion (14) acting on 2 different heights receives its speed of rotation from the group of 6 wheels and redistributes it to the group of 12 wheels. This pinion (14) may be positioned at any point provided that its pitch diameter is tangent to a wheel in the inner group and tangent to a wheel in the outer group. The number of wheels in the group of 12 being even, the direction of rotation of the mobile is alternately clockwise and anti-clockwise, therefore allowing the describing of a loop without stopping the mobiles.

FIG. 6 shows the two levels of meshing of the group of 6 wheels and the group of 12 wheels. It represents a cross section between an inner wheel (12) and an adjacent outer wheel (13). We notice in the cross section in FIG. 6 the two level heights between the inner wheels (12) and the outer wheels (13). On these wheels (12 and 13) are placed patches (not shown) representing the disks in FIGS. 1 to 4.

The mechanism represented in the drawing may comprise an impulse device (not shown) constructed to move the disks (2 and/or 4) in jumps of 30° for example, a time period of one hour being designed to elapse between successive jumps. It is thus possible to indicate the time using the 18 disks (2 and 4), the design or image placed on the disks (13) then being the succession of numbers representing the twelve hours represented in FIGS. 3 and 4. The movement (successive recomposing of the numbers) is timed by the impulses received by the centre mobile of our module when it is assembled on a jumping hour movement or module. The jumping hour movement or module inevitably contains an hour wheel which jumps, as its name suggests, from hour to hour, making jumps of 30°.

The advantage of this arrangement is that it is possible to indicate the time without an hour hand if desired, the number representing the current hour being recomposed in one go and remaining displayed for a full hour.

Reading of the time becomes easier than in the case of a trailing mechanism as mentioned above, but another advantage is that it is possible to use the hour hand of the basic mechanism, for two purposes:
to allow easy standard reading of the time;
to use the hour hand or the number (according to the choice or the taste of the final wearer) as a second time zone.

The hour hand can be replaced by a transparent disk (sapphire disk) comprising a translucent area of a different colour so as to indicate the place at which the recomposed number must be read, thus facilitating quick reading of the time.

In a variant, the hour can be indicated on the circumference of the dial only by means of the twelve disks (2) mounted on the outer wheels (13), the inner disks (4) being used to display other indications.

Generally speaking, the mechanism which has just been described in FIGS. 1 to 6 of the drawing offers the following possibilities:
The disks (2 and 4) may or may not appear on the dial, that is to say that it is possible to move only one of them or a desired number between 1 and 18 or several groups of disks.
The disks (2 and 4) are or are not positioned at the same level as the level (0) of the dial (they may stand out or be inlaid).
The design or the decorations of these dials may or may not represent a coherent design.
The disks (2 and 4) may be treated galvanically or by all currently known means of dial decoration, i.e. mounted, jewelled, engine-turned, transferred; engraved, cut, etc.
The disks (2 and 4) may all be identical transfers or they may be different, grouped by type or not.

The mechanism is constructed to perform the action of disassembling and reconstituting a single design, sign or logo or several designs, signs and logos on the same dial. In addition t the numbers, the dial may for example carry an image which will be reconstituted at a chosen time.

The mechanism may control the 12 outer disk (2) in one of the ways cited above, but rotate the 6 inner disks (4) (or only one of these disks) at a speed different from that of the 12 outer disks (2), so as to indicate for example AM/PM by means of coloured disks alternately representing day and night.

The mechanism has the possibility of being added to a mechanism with a tourbillon carriage or any other mechanism implying that one or more disks are not used. For example, the inner disks (4) and possibly two or three disks (2) may be removed to allow the tourbillon carriage to pass through.

With regard to the materials used: Depending on the range and quantity of the parts manufactured, the components forming the mechanism (dials, disks (2 and 4), wheels (12, 13), etc.) may be made of machined or injected synthetic materials or machined or injected metal.

According to a preferred mode of execution, the mechanism cited as an example has an external diameter of 30 mm and contains disks visible on the dial side with a diameter of 5.7 mm. The dial has a thickness of 0.4 mm.

Obviously, for the same principle used in a smaller-sized watch, for example a ladies' watch, or a watch of intermediate size, the dimensions of the dial and the disks will be different. Finally, the number of these disks may vary between 1 and 50.

The mechanism may furthermore be used for larger timepieces (ranging from small clocks to floral clocks in squares in large towns).

The series of 6 inner disks (4) may be replaced by 7 disks which indicate the day of the week (Monday to Sunday) and the series of 12 outer disks (2) would indicate the months and the transfer or design of the dial which could comprise the four seasons, the equinoxes and the solstices, etc.

According to a variant of the mechanism, it is possible cover the gears of the 18 mobiles (12, 13) of the module shown in FIG. 5 with a plate. This plate then comprises 18 holes of small diameter positioned on the axes of rotation of the 18 wheels enabling pins to come out through the holes to move objects attached to their end. These objects may take the form of small plates of various shapes (all possible geometrical shapes) with the aim either of animating parts in three dimensions or using them as “covers” for the lower plate. These shapes may give the impression of being actuated by each other. For example, with half-circles alternately showing “hearts” and “spades”, the whole dial can be decorated alternately with “hearts” and “spades”.

These parts added at the end of the pins may be shapes capable of passing from one part to another a precious stone mounted in a cylindrical cap so that this stone indicates the minute. If 12 disks complete one revolution in 10 minutes, or one half-turn in 5 minutes, they carry the stone from one module to another along a gallery milled in the basic dial in 12×5 minutes=60 minutes.

Finally, it is possible for the disks required to be rotated not to be located in the same parallel plane as the plane in which the hours and minutes are indicated. For example, it is possible to imagine a conical bezel with disks arranged in a circular fashion in the plane of the cone and, in order to operate the small disks in another plan, their being linked with a carbon fibre cable or equivalent.

1. Mechanism for display of animated numbers and/or figures or signs on a timepiece dial, wherein it comprises at least one toothed wheel placed under an opening of a dial of a timepiece and driven by means of a mobile which is itself linked with the basic movement of the timepiece, the toothed wheel being surmounted by a small plate carrying at least one figure or sign designed to be animated in relation to the dial.

2. Mechanism according to claim 1, wherein it comprises several toothed wheels linked with each other or controlled separately or in groups.

3. Mechanism according to claim 2, wherein it comprises a first series of 12 toothed wheels placed on the outer part of the mechanism.

4. Mechanism according to claim 3, wherein it comprises a second series of 6 toothed wheels placed between the centre of the dial and the first series of 12 toothed wheels.

5. Mechanism according to claim 3 wherein the small plates surmounting the toothed wheels are disks designed to rotate in a corresponding opening in the dial.

6. Mechanism according to claim 5, wherein the disks are positioned at the same level as the dial.

7. Mechanism according to claim 5, wherein the disks are positioned to stand out with respect to the level of the dial or be inlaid under the dial.

8. Mechanism according to claim 5, wherein the mechanism is constructed to animate at least one or several groups of disks.

9. Mechanism according to claim 5, wherein the disks are used to display any chosen design, image or sign, or the hour, the minute, the month the days of the week, the seasons, the equinoxes, the solstices, day and night etc.

10. Mechanism according to claim 5, wherein the disks and the dial are treated galvanically or are mounted, jewelled, engine-turned, transferred, engraved, cut, etc.

11. Mechanism according to claim 1 wherein it is constructed to drive the small plates or the disks at constant speed.

12. Mechanism according to claim 1 wherein it is constructed to drive the small plates or the disks in jumps corresponding to an instantaneous angular movement of, for example, 30°.

13. Mechanism according to claim 5, wherein the dial has a diameter of 30 mm, the disks visible on the dial side having a diameter of 5.7 mm and the dial having a thickness of 0.4 mm.

14. Mechanism according to claim 5, wherein it is produced with its components, its disks and its dial made of injected or machined synthetic material or injected or machined metal.

15. Mechanism according to claim 5, wherein the dial and its disks present one or several numbers, figures or signs.

16. Mechanism according to claim 1 wherein the small plates are disks, hearts, spades, clubs, etc., or are fitted with precious stones or decorations.

17. Mechanism according to claim 4, wherein the small plates surmounting the toothed wheels are disks designed to rotate in a corresponding opening in the dial.

18. Mechanism according to claim 5, wherein is constructed to drive the small plates or the disks at constant speed.

19. Mechanism according to claim 5, wherein it is constructed to drive the small plates or the disks in jumps corresponding to an instantaneous angular movement of, for example, 30°.

20. Mechanism according to claim 5, wherein the small plates are disks, hearts, spades, clubs, etc., or are fitted with precious stones or decorations.
